(19) United States
(12) Patent Application Publication
(10) Pub. No.: US 2026/0248145 A1
(43) Pub. Date: Aug. 27, 2026

(54) DRY SWEET DOUGH MIX FOR HOME BAKED AND COOKED GOODS

(71) Applicant: Theresa Johnson-Blount, Baton Rouge, LA (US)

(72) Inventor: Theresa Johnson-Blount, Baton Rouge, LA (US)

(21) Appl. No.: 19/064,818

(22) Filed: Feb. 27, 2025

Related U.S. Application Data
(62) Division of application No. 17/563,827, filed on Dec. 28, 2021, now abandoned.

(51) Int. Cl. A21D 10/00; A21D 8/02

(52) U.S. Cl. CPC A21D 10/005; A21D 8/02

(57) ABSTRACT

A commercially prepared dry sweet dough mix, and preparation method therefor, for use in making a batter to prepare of home baked cooked goods having a sweet flavor. The dry sweet dough mix includes a mixture of component ingredients such as flour, chemical leavening agent, non-fat dry milk solids, eggs, and a sweetening agent, which are disposed in a preparation bag. Once the component ingredients are combined and finished, they may be advantageously stored in the preparation bag at a wide range of temperatures. To be used, the dry sweet dough mix is hydrated and massaged into a batter while still in the preparation bag in two to five minutes. Once prepared in this manner, the batter does not need any kneading or fermentation steps and may be baked or cooked in a conventional manner into products such as pies, dumpling, tea cookies or teacakes.

### CROSS REFERENCE TO RELATED APPLICATIONS

This application is a divisional of, claims the benefit of, and incorporates by reference co-pending U.S. patent application Ser. No. 17/563,827, which was a continuation in part of, claimed the benefit of, and incorporated by reference co-pending U.S. patent application Ser. No. 13/847,480, filed Mar. 19, 2013 and a continuation in part of, claimed the benefit of, and incorporated by reference co-pending U.S. patent application Ser. No. 15/179,928, filed Jun. 10, 2016.

### BACKGROUND OF THE INVENTION

### Field of the Invention

This invention relates generally to invention relates to food products, and more particularly, to a farinaceous dry mix for use in the preparation of baked or cooked goods.

### Description of the Prior Art

For many types of food products, there generally many known home baking and cooking methods for which scratch ingredients are utilized. One type of food product that is commonly prepared with scratch ingredients is a pie. Pies have addressed the need for nutritious, easy to transport, and long lasting foods on long journeys for thousands of years. Indeed, it is understood that American colonists would frequently prepare pies that included a filling baked into a shell since it served to preserve the foods that filled them. Because these pies would keep fresh during the winter months, the colonists would be able remain nourished even in times when fresh food was not readily available.

Historically, it is generally understood that most food products had to be prepared with scratch ingredients due, among other things, to limitations in food preservation techniques and transit times various locations. Indeed, from the 16th century until the present day, the shell of a pie is commonly an edible tasty crust prepared from scratch ingredients and spread out in a dish, such as a pie dish.

While the use of scratch ingredients to prepare such items is often still romanticized as being more authentic or having a better taste, it is inescapable that the use of scratch ingredients requires more time and effort. For example, preparation methods employing scratch ingredients for a typical crust dough mixture may call for a series of tedious and time consuming steps, including ingredient mixing and product working, in order to enable the provision of baked or cooked goods which exhibit desirable flavor and texture attributes. In one exemplary cookbook procedure for making the dough of a pie, a user must perform at minimum the following steps: cream soft butter and sugar in a bowl (at least 3-5 minutes); mix eggs and vanilla until well blended and fluffy (3 minutes); stir in flour mix with other ingredients and mix thoroughly for (2 to 3 minutes); place on a floured board, roll out, place in pan and filled with filling (2-3 minutes); and bake until cook or done (30-45 minutes).

In circumstances wherein a yeast dough is desired, once the dough mix is prepared, it must be: placed in a bowl and allowed to rise another 1 to 1½ hours (intermediate proof) until the volume has doubled; hand shaped and divided to form units for baking; and placed into pans and allowed to rise for another 30 minutes to double the volume (final proofing). Only then can the dough be baked and cooled. Altogether, such processes require from 3½ to 5 hours, or more, to complete. Thus, even in processes described for so called “quick” yeasty breads in popular cookbooks, a minimum of 2½ to 3 hours is still required to complete the various steps.

Past attempts to reduce the preparation time of various pastry dough mixes have taken generally one of two approaches: (1) a provision of products allowing reduction in fermentation step times or (2) a provision of products allowing elimination altogether of the lengthy fermentation step. Nonetheless, a problem which still exists is that in the preparation of dough mixtures for a pie (or other food product employing pastry dough) typically require lengthy preparation steps which are largely unchanged over the last five centuries. Thus, there remains a need for a dry sweet dough mix which can be used to prepare home baked cooked goods in as little as two (2) to five (5) minutes. It would be helpful if such a dry sweet dough mix was suitable for use at room temperature, refrigerated or frozen. It would be additionally desirable for such a dry sweet dough mix to be produced to enable the preparation of sweet cooked or baked goods in a non-commercial, home setting and not require dough working and extended preparation steps by the consumers.

The Applicant's invention described herein provides for a dry sweet dough mix for home baked cooked goods which eliminates the vast majority of time and effort required by an end user to prepare a dough for baking. The primary steps in the preparation of Applicant's dry sweet dough mix are combining the component ingredients into a sweet dry dough mix, finishing the dry sweet dough mix, and packaging the finished dry sweet dough mix. When in operation, the dry sweet dough mix enables near immediate preparation of a dough exhibiting a soft dumpling or a bake good with a cookie-like textures. As a result, many of the limitations imposed by prior art structures are removed.

### SUMMARY OF THE INVENTION

A commercially prepared dry sweet dough mix, and preparation method therefor, for use in making a dough to prepare of home baked cooked goods having a sweet flavor without requiring dough kneading or lengthy preparation steps. The dry sweet dough mix comprises a mixture of component ingredients such as flour, chemical leavening agent, non-fat dry milk solids, eggs, and a sweetening agent, which are disposed in a preparation bag. Once the component ingredients are combined and finished, they may be advantageously stored in the preparation bag at a wide range of temperatures. To be used, the dry sweet dough mix is hydrated and massaged into a dough while still in the preparation bag in two to five minutes. Once prepared in this manner, the dough does not need any kneading or fermentation steps and may be baked or cooked in a conventional manner into products such as pies, dumpling, tea cookies or teacakes.

It is an object of this invention to provide a dry sweet dough mix which can be used to prepare home baked cooked goods in as little as two (2) to five (5) minutes.

It is another object of this invention to provide a dry sweet dough mix suitable for use at room temperature, refrigerated or frozen.

It is yet another object of this invention to provide a dry sweet dough mix which is produced to enable the preparation of sweet cooked or baked goods in a non-commercial, home setting and not require dough working and extended preparation steps by the consumers

These and other objects will be apparent to one of skill in the art.

### BRIEF DESCRIPTION OF THE DRAWINGS

FIG. 1 shows the steps through which a dry sweet dough mix for home baked cooked goods is prepared in accordance with the present invention.

FIG. 2 shows the steps through which a dough is prepared from a dry sweet dough mix for home baked cooked goods prepared in accordance with the present invention.

### DETAILED DESCRIPTION OF THE INVENTION

A dry sweet dough mix for use in the preparation of a sweet cooked or baked crust, or other pastry dough product, without requiring dough working or lengthy dough preparation steps. In one embodiment, the dry sweet dough mix defines the component ingredients of (1) flour having an average vital gluten content of at least about 5% by weight, (2) a chemical leavening agent, (3) a sweetening agent, (4) non-fat dry milk solids, and (5) a powdered form of whole eggs. In some embodiments, the component ingredients may additionally include powdered butter, flavoring ingredients, coloring ingredients, preservation ingredients, and nutritional ingredients. When combined and finished in accordance with the present disclosure, these component ingredients form a dry sweet dough mix that, once hydrated, can be massaged into a dough which can be cooked or baked in a conventional manner to provide cooked or baked goods with both desirable high specific volume and sweet cookie like texture. Advantageously, cooked or baked goods prepared from the dry sweet dough mix of the instant disclosure require no kneading or dough working steps.

Throughout the specification and claims, percentages are by weight based upon 100 parts flour, and temperatures are in degrees Fahrenheit unless otherwise indicated.

Flour. The main ingredient of the present dry sweet dough mixes is conventional flour. Many suitable flours are those conventionally employed in the preparation of sweet cooked and baked goods and selection of appropriate flours pose no problems for the skilled cook. Suitable flours are broadly made from cereal grains such as wheat, rye, oats, barley, corn, and the like. Various mixtures of flours can be used, such as multi-grain mixtures of oat flour, wheat flour, barley flour, rye flour, and the like.

In one embodiment, a gluten free flour may be employed as the main ingredient of the present dry sweet dough mix.

Chemical Leavening Agent. Another essential ingredient of the present dry sweet dough mixes is a conventional dry chemical leavening agent. The selection of a suitable chemical leavening agent or system from those known in the art will pose no problem for one skilled in the formulation of culinary dry mixes for baked goods. In general, such suitable systems are composed of a baking powder, baking soda (i.e. sodium, potassium, or ammonium bicarbonate) or other like substance as a source of carbon dioxide on one hand, and one or more other common baking acids on the other.

In one embodiment, the chemical leavening agent makes up between about 0.2 to about 4.0 percent by weight of said total dry sweet dough mix.

Sweetening Agent. A component in some embodiments of the dry sweet dough mix composition is a dry “nutritive carbohydrate sweetening agent,” such as sugar. The term nutritive carbohydrates sweetening agent is used herein to refer generally to conventional dry sweetening agents used in food products.

Non-Fat Dry Milk Solids. A component in some embodiments of the present dry sweet dough mix is non-fat dry milk solids. The non-fat dry milk solids may be added to the present dry sweet dough mixes to improve dough mixing and water mixing times, to permit the use of more water, and to speed the crust coloring of the baked goods and thus to decrease baking times.

Whole Eggs. A very highly preferred component in some embodiments of the present dry sweet dough mix is whole egg. It is contemplated that the whole egg is added to the mixture in a dry form.

Powdered Butter. A component in some embodiments of the present dry sweet dough mix is a butter ingredient in a quantity between 1 part to 10 parts. Such a concentration relative to the flour is advantageous improving textural quality of a resulting sweet cooked or baked goods made from the dry sweet dough mix.

Miscellaneous Optional Ingredients. A variety of optional incidental ingredients can be added to the present dry sweet dough mixes including flavors, colors, spices, preservatives, butter, vitamins and the like.

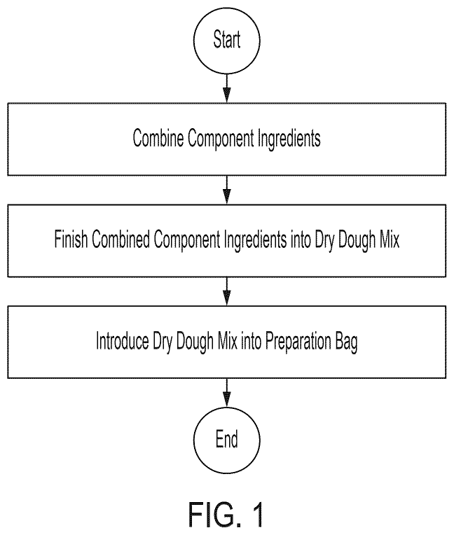

Referring now to the drawings and in particular FIG. 1, a dry sweet dough mix for home baked cooked goods is prepared by combining the component ingredients together in a receptacle so they are mixed into a free-flowing dry mixture. In some embodiments, the component ingredients are mixed by stirring, whisking, blending or beating. In one embodiment, the dry sweet dough mix is prepared with the flour, the leavening agent, and milk solids being blended together.

Next, the free-flowing dry mixture is finished into the dry sweet dough mix of the instant disclosure in a standard commercial finisher, such as a VARIMIXER® W150PL Commercial Mixer, Hobart Legacy® Floor Mixer HL600-1STD or another commercial planetary mixer. By finishing just the dry ingredients which form the free-flowing dry mixture into the dry sweet dough mix and more intimately incorporating the component ingredients by impact mixing, it is appreciated that subsequent preparation time of dough from the finished dry sweet dough mix can be reduced and the chance for lumps in subsequently prepared dough is reduced, even when a hydrating agent is added after the free-flowing dry mixture is finished.

Advantageously, by the use component ingredients which are in a dry and particulate form and the addition of the step of finishing, the dry sweet dough mix can be (1) stored or transported at a range of temperature environments, including a room temperature environment (up to 78 degrees), in a conventional refrigerator (between 33 and 40 degrees), and in a conventional freezer (between −10 degrees and 32 degrees) and (2) used immediately (without the need for warming/thawing or cooling) to make dough that is ready to bake/cook once removed from storage (or transport) without effecting the texture of a finished product.

Once finished, the dry sweet dough mix may be packaged in a single use, impermeable preparation bag which is sized to allow for storage and transport of the dry sweet dough mix as well as the subsequent preparation of dough as described below. It is contemplated that the dry sweet dough mix is packaged in a bag or other receptacle suitable for end user, home use. For example, it is appreciated that four (4) to ten (10) mil. which are resealable Polyethylene bags may be employed because they provide an air and water barrier and are both strong and flexible enough to allow the dry sweet dough mix to be massaged into a dough while still disposed therein.

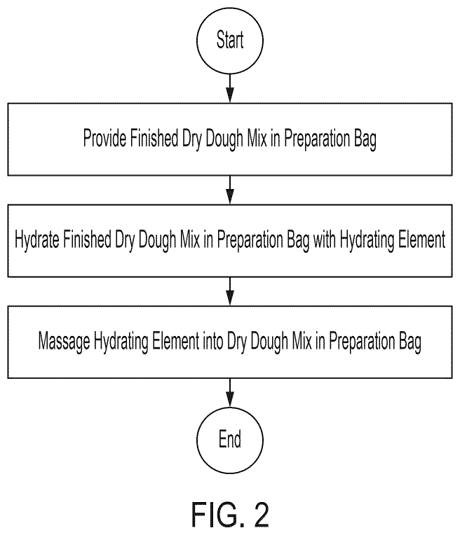

Referring now to FIG. 2, a dry sweet dough mix in accordance with the present disclosure may be conveniently prepared into finished sweet cooked or baked goods by first forming a dough. A dough is formed from a dry sweet dough mix disposed in a preparation bag by first adding a hydrating agent to the preparation bag. In some embodiments, the hydrating agent defines water, while in others it defines a fat based substance such as milk, butter, or shortening. In other embodiments, the hydrating agent includes water and such a fat substance.

Advantageously, sweet baked or cooked goods prepared from sweet dough made from a dry sweet dough mix of the instant disclosure require no kneading or stirring steps after being hydrated and is characterized by a fermentation step of significantly reduced time. In addition, Once the dry sweet dough mix is hydrated, the hydrated mixed is massaged by hand through exterior of the preparation bag, thereby forming the dough. It is contemplated that the term massaging is used herein to describe light rubbing by hand without the use of a utensil.

The process of hydrating the dry dough mix and massaging into a dough takes only two (2) to three (3) minutes. Once the dough is formed, the dough may be rolled out, cut into pieces, and/or transferred into a suitable pot or baking pan. Baked or cooked goods can be used for pies, dumpling, cobblers, tea cookies or teacakes and baked or cooked in a conventional manner.

It has been found that increasing batch size has only a modest adverse impact on the specific volume of the finished baked goods realized. It is believed that the adverse impact results simply from the difficulty in massaging the dry sweet dough mix into dough when larger batch sizes are used. Thus, it is preferable to prepare two batches of the present mix than to prepare or double the batch to realize similar amounts of finished baked goods.

Advantageously, because the dry sweet dough mix is formed only from dry particulate material, its shelf life is generally longer that many conventional batter mixes. In addition, because the dry sweet dough mix can be refrigerated or frozen without effecting the texture of the dry sweet dough mix or the resultant dough (or baked good), the shelf life of the dry sweet dough mix may be extended indefinitely. It is additionally noted that because the dough is prepared from the dry sweet dough mix in the accompanying preparation bag, the clean up requirements following the use of the dry sweet dough mix are greatly reduced relative to existing preparation methods.

In addition, is further noted that the inclusion of the non-fat dry milk solids significantly enhances the dough (and baked good) made from the dry sweet dough mix. As mentioned before, the non-fat dry milk solids improve dough mixing and water mixing times, permit the use of more water (for easier mixing without ruining the texture), and to speed the crust coloring of the baked goods (to decrease baking times). And because non-fat dry particulate milk is particularly used (and thoroughly combined through impact mixing), the inclusion of the non-fat dry milk solids does not reduce the range of temperatures at which the dry sweet baking mix can be used.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method of preparing a dry dough mix suitable for use without dough kneading or fermentation, comprising the steps of:
combining a plurality of component ingredients into a free-flowing dry dough mix, wherein said component ingredients each are defined by dry, particulate materials;
wherein said component ingredients include at least flour, a chemical leavening agent, and at least one of a whole egg in a dry form and powdered butter;
finishing in a planetary mixer only the dry, particulate materials of the dry dough mix so as to remove lumps in the dry dough mix, wherein after the step of finishing, the dry dough mix is useable to form a batter suitable for cooking within five minutes of an introduction of a hydrating agent solely without requiring kneading; and
wherein after said step of finishing, the dry dough mix is useable to form the batter while the dry dough mix is at a temperature in a range of between −10 degrees and 78 degrees Fahrenheit.

2. The method of claim 1, wherein the chemical leavening agent constitutes between 0.2 and 4.0 percent of the dry dough mix by weight.

3. The method of claim 1, wherein the flour employed as one of the component ingredients amongst the plurality of component ingredients is defined by an average vital gluten content of at least 5%.

4. The method of claim 1, wherein said component ingredients additionally include dry milk solids.

5. The method of claim 4, wherein said dry milk solids define non-fat dry milk solids.

6. The method of claim 1, wherein said component ingredients additionally includes a sweetening agent.

7. The method of claim 1, additionally comprising the step of introducing said finished dry dough mix into a bag adapted to provide an air and moisture barrier for contents disposed in the container.

8. The method of claim 1, wherein the hydrating agent defines at least one of a fat substance and an aqueous liquid.
